(19) United States
(12) Patent Application Publication
(10) Pub. No.: US 2010/0018725 A1
(43) Pub. Date: Jan. 28, 2010

(54) Helibucket for Firefighting Helicopters

(76) Inventor: Constantino Ramos Rodriguez, Alcazaren (Valladolid) (ES)

Correspondence Address: EUGENIO J. TORRES, 221 PLAZA BUILDING, PONCE DE LEON, SUITE 403, SAN JUAN, PR, 00917, US

(21) Appl. No.: 12/518,442

(22) PCT Filed: Dec. 10, 2007
(86) PCT No.: PCT/ES2007/000730

§ 371 Date: Jun. 10, 2009

(30) Foreign Application Priority Data
Dec. 11, 2006 (ES) P200701638

(51) Int. Cl. A62C 39/00

(52) U.S. Cl. 169/53

(57) ABSTRACT

The helibucket is for loading, transporting and discharging water and products on fires and hangs from the loading hook of a helicopter. It is formed by a head which is linked to the helicopter, fastening cables, a cover with the foam tank, the floater and the mechanisms box, the base, which supports the weight and houses the discharge valve, the autonomous filling valves and the pump and a flexible canvas which joins the cover with the base. A motor with three reels for winding the cables controls the loading, unloading and folding. Hermetic closing is achieved since the surface of the bottom of the bucket is greater than that of the valve, and on taking weight, the helibucket moves downwards to the elastic limit of its cables, forcing the body of the valve against the valve gates thereby closing it. The helibucket is useful for extinguishing forest fires, increases to a great extent efficiency in firefighting as it transports 100% of the water it loads and enables the pilot to control how and how much water it discharges.

### RELATED APPLICATIONS

This application claims priority under 35 USC 371 based upon PCT/ES2007/000730 filed Dec. 10 2007.

### STATEMENT REGARDING FEDERALLY SPONSORED RESEARCH AND DEVELOPMENT

N/A

### BACKGROUND OF THE INVENTION

1. Field of the Invention

This invention is a bucket that is suspended from the loading hook of a helicopter and is used to carry water and drop it on a fire as an extinguisher.

2. Technical Field of the Invention

Tanks attached to conventional helicopters are widely used in firefighting. Some types are attached to the belly of the helicopter and other types are suspended as if they were an external load.

These tanks are used to drop water and some chemical agents, such as foaming and retardant agents that increase the effect of water, on fires.

Helicopters take water from ponds, lakes, swimming pools, etc, with buckets suspended from cables and chains. These buckets are filled and emptied by means of a valve in the lower part of the bucket. Water is transported to the area of the fire and dropped there.

### DISCUSSION OF THE BACKGROUND

This invention is a bucket that is suspended from a helicopter. It is formed by a head that is linked directly to the helicopter, fastening cables that support the weight, a flexible canvas tank to hold the water and a valve to discharge the water.

The advantages of the buckets include allowing the helicopter to fly at a greater altitude over the fire and allowing the tank to be refilled from a greater altitude than in the case of tanks attached to the belly of the helicopter. It is also important to indicate the force of the discharges because it is possible to build tall buckets and apply great pressure on the discharge valve.

Despite all these advantages, buckets also have some disadvantages. Their efficiency is reduced because they lose water during flight through the valve and through the top. Furthermore, turbulences are generated when the water is discharged, so it mixes with air and evaporates faster.

There are currently different types of buckets that incorporate upward-opening valves fitted to the lower part of the tank.

The equipment currently used in firefighting is not as efficient as would be desirable, is hard to operate and presents problems such as the large amount of water it loses en route to the fire, both because of the incorrect closing of the discharge valve and because of the venturi effect on the intake, where air sucks the water through the top. Additionally, the filling is very slow.

When tackling the fire, the pilot cannot decide the amount of water to be used or the way in which to discharge it. Fires are all different from one another: when a fire occurs in trees, the jet of water needs to be laminar and the discharge needs to be done from high altitude so as to avoid colliding against the trees. On the other hand, when a fire occurs in bushes or stubble, a rain-type discharge is needed.

On the return trip, the empty helibucket cannot be folded, so it creates a lot of drag and thus limits the helicopter's speed and increases its fuel consumption.

The metal structures it requires to shape it are heavy and therefore limit the payload and hamper its handling by ground crews.

### SUMMARY OF THE INVENTION

The invention attempts to provide a helibucket of the type mentioned above that incorporates a leaktight valve, with an electromechanical system that allows the pilot to control the amount of water it loads, manage the discharge by directing the jet of water (opening and closing the valve as needed) and fold it in flight when it is empty. It also needs a top cover and an electronic system of sensors that controls the amount of water that the helicopter can load. These changes shall make the loading, transport and discharge of water by firefighting helicopters more efficient.

### BRIEF DESCRIPTION OF THE DRAWINGS

The accompanying drawings which are incorporated herein constitute part of the specifications and illustrate the preferred embodiment of the invention.

FIG. 1 shows a section view of the half-folded helibucket in flight.

FIG. 2 shows two views of the base.

FIG. 3 shows two views of the cover.

### DESCRIPTION OF THE INVENTION

This invention is a helibucket that is fitted with a gate valve with the following features: it allows the fast filling from the bottom, it is leaktight, it allows different types of discharge and it allows the loaded water to be discharged at different times.

The valve is fitted onto a base built with compound materials. This base supports all the weight that is transferred to the head through cables, and it also supports the pump and the circular fast-fill valves.

A strong, flexible and leaktight canvas links the base and the cover.

The cover prevents the water from being sucked out by air and acts as a float to allow the helibucket to fill. It also allows the bucket to float so as to facilitate recovery it the pilot is forced to jettison it.

The cover includes a tank with a dosing pump that adds foaming or retardant agent to the water to increase the extinguishing effect.

The cover and the base join and collect inside them the canvas to facilitate transport and reduce drag during flight.

The cover includes a motor that actuates a system with three reels to wind the cables used for the opening and closing of the valve. This is used for the filling and for the various discharge systems, as well as for the in-flight folding of the helibucket when the base and the cover are joined. It also includes a positioner with the end-stops that stop the motor when the correct position is reached, as well as contactors that actuate the fill pump and the foam dosing system. This same compartment has an electronic circuit that works in conjunction with the external and internal sensors to detect the water level outside and inside the helibucket. It then sends the adequate commands to start up or shut down the pump when the preset fill level is reached. It also partially opens the discharge valve to release any excess water, as a function of the power of the helicopter, and it closes the gates once the preset value is reached.

The cables that transfer the weight from the base to the helicopter loading hook are attached to the head. This head is of horizontal design so that it does not hit the ground when landing.

A helibucket with the design of the invention presents certain advantages.

The downward opening of the gate valve allows a laminar discharge because there are no obstacles at the top.

The degree of opening of the valve can be adjusted to allow a cone-shaped jet to be discharged. In this way, the amount of water used is reduced and the surface covered is increased.

To achieve this, the invention focuses on placing upward-closing valve gates at the bottom so as to use the weight of the water to close. The surface of the gates is smaller than the surface of the rest of the bucket, so the force that water applies on the fixed part (above) is greater than the force on the gates, thus ensuring leaktightness.

The motor with three reels for the winding of the two cables that actuate the gates plus the balance cable allows the valve to be opened and closed for several discharges. It also allows the helibucket to be folded up in flight to considerably reduce drag and therefore reduce fuel consumption and increase speed.

A fill pump at the base allows water to be pumped up from shallow streams and ponds.

The moisture detectors allow the electronic unit to control the filling. More water can be pumped up as the fuel level in the helicopter drops, thus ensuring the maximum possible efficiency without putting the pilot or helicopter at risk.

The electronic control of the unit ensures that no foaming agent that could pollute the river is released accidentally.

Below is a description of the invention by means of an example and with references to the attached figures.

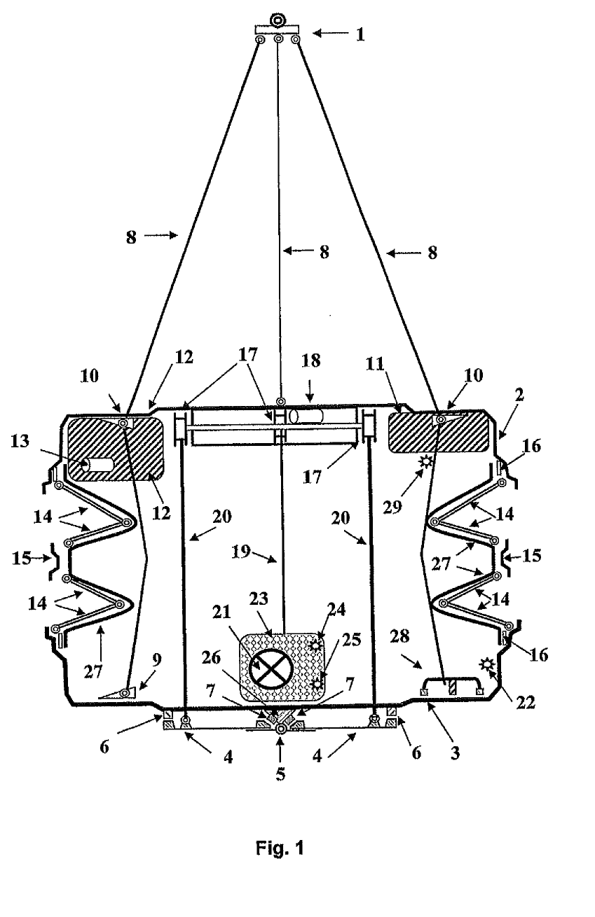

FIG. 1 shows a section view of the half-folded helibucket in flight. It shows the cables (8) that are attached to the head 1, the cover 2 that includes the cables supports 10, the box with the motor 18, the three reels 17, the float 11, the foam tank 12 with its dosing pump 13 and the closing joint 16 between the canvas and the cover.

The canvas 27 folds by means of a scissor-type mechanism 14 which, together with at least one intermediate belt 15 that keeps it stretched while it is filling up and serves as intermediate support for the scissor-type mechanism, joins the base and the cover by means of a leaktight joint 16.

The base 3 has supports 9 where the cables 8 are attached. These cables transfer the load to the head 1, which is linked to the helicopter. The joint 6 is leaktight and is housed in a machined slot at the base. The bridge 26 contains the supports of the shaft 5 for the opening and closing of the hinged valve gates 4. The middle bridge has two slots at a 45° angle with respect to the base where the joints 7 are housed. These serve to close the valve.

The valve 4 is formed by two gates that are actuated by means of the cables 20 from the reels 17.

The fill pump 21 is located on the side of the base. It includes a filter 23, and on the outside it has a high-level sensor 24 and a low-level sensor 25 that sends a command to the controller to start up and shut down automatically whenever the bucket hits the water. On the inside of the helibucket there is a low-level sensor 22 and a high-level sensor 29 that are used to control the amount of water that is loaded.

The autonomous fill valves 28 are included in the base to reduce the fill time when the fill is done by immersion.

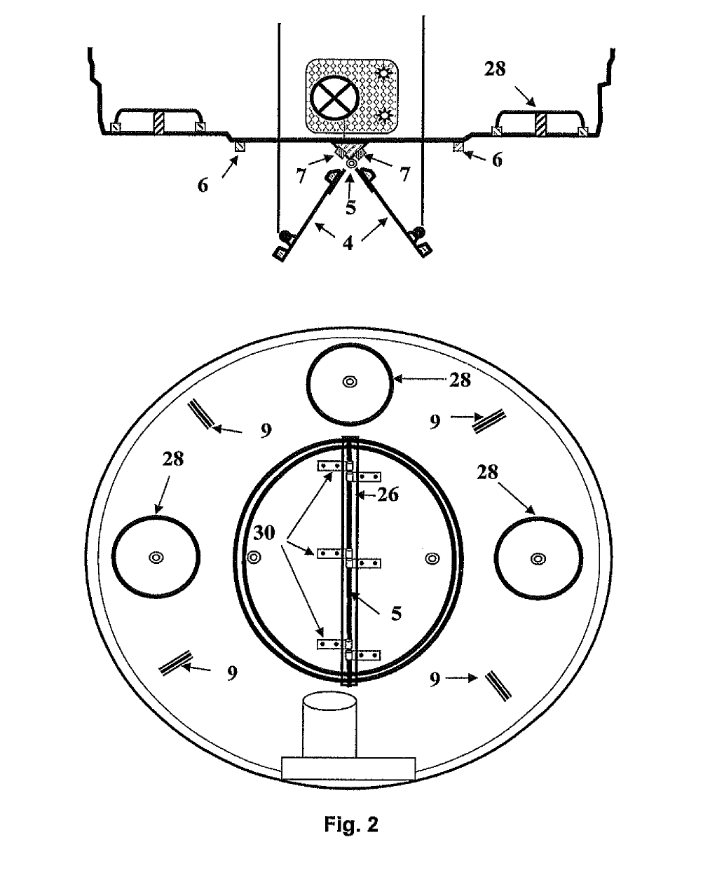

FIG. 2 shows two views of the base. The valve is shown with the gates 4 at the half-open position. The fast fill valves 28, the cable supports 9 and the bridge 26 are also shown.

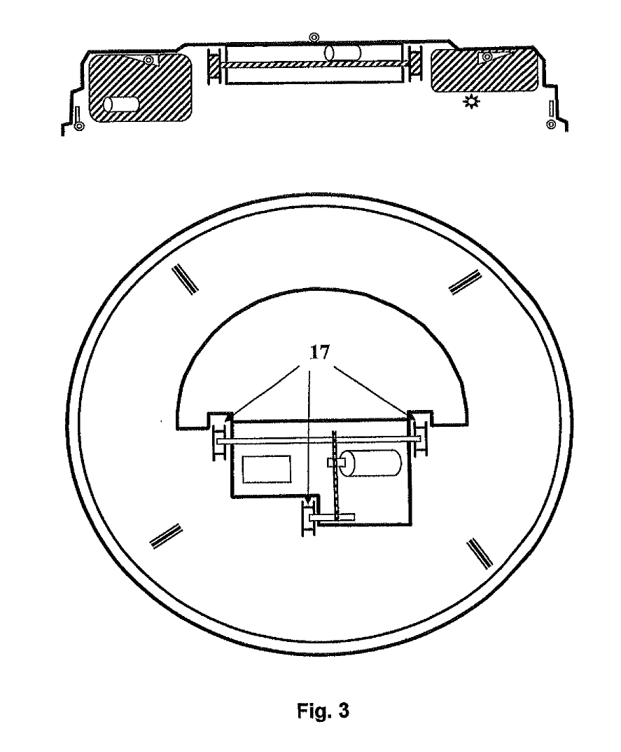

FIG. 3 shows two views of the cover. The gate actuator motor turns the reels 17 by means of a transmission to wind the cables during the loading and unloading operations and during the folding of the helibucket in flight.

1. Helibucket for firefighting helicopters comprising a helibucket, wherein said helibucket transports any external load with helicopter and comprises a head that is attached directly to a helicopter, cables wherein said cables support the weight connected to said helicopter, a flexible canvas container wherein said canvas container holds water and a base with discharge valve wherein said discharge valve comprises a two-gate valve that is hinged along a central shaft wherein said gates open downward by means of said cables and are leaktight against the helibucket main body by means of a joint installed at the bottom of the base and the joints of the bridge and said two gates close upwards thanks to the pressure of the water moving the base downward and pressing the joints against the gates.

2. Helibucket for firefighting helicopters as in claim 1, wherein said opening and closing of said two gates is done by means of mechanical hinges that facilitate the operation without stressing the valve for unlimited number of discharges.

3. Helibucket for firefighting helicopters as in claim 2, said hinge is supported on a central bridge, wherein said two gates deflect the jet of water to the sides to obtain a fan-shaped discharge.

4. Helibucket for firefighting helicopters comprising helibucket and a cover, wherein said cover is closed along its perimeter and prevents a product inside said helibucket from spilling out either by splashing or by the suction of air during flight.

5. Helibucket for firefighting helicopters comprising helibucket and a cover, wherein said cover comprises a mechanism with an electromechanical actuator and a positioner that turns three reels with a motor and control cables wherein said control cables open and close a valve to divide a jet up into several discharges or to shape it as a fan or as a single, laminar and powerful jet.

6. Helibucket for firefighting helicopters as in claim 5, comprises an actuator wherein said actuator opens the gates completely to allow the filling through a bottom valve making the filling operation faster and safer than by turnover.

7. Helibucket for firefighting helicopters as in claim 6, comprising a height-adjustable moisture sensor that detects whether the fill level is excessive and sends information to its electronic circuit to partially open the gates and thus release excess water controlling the helibucket's load electronically.

8. Helibucket for firefighting helicopters as in claim 5, comprising an actuator that turns reels and winds cables until the base links up to the cover to fold the helibucket in flight.

9. Helibucket for firefighting helicopters comprising helibucket and a base, wherein said base comprises a fill pump with a filter and an electronic circuit comprising external sensors and internal sensors wherein said electronic circuit automatically connect and disconnect the pump until the programmed load is reached.

10. Helibucket for firefighting helicopters comprising a helibucket wherein said helibucket folds up vertically by means of several scissor-shaped hinges on its perimeter together with at least one belt that controls the canvas during a folding operation.

11. Helibucket for firefighting helicopters comprising a helibucket and a cover, wherein said cover comprises a foaming agent tank with a dosing pump and a float.

12. Helibucket for firefighting helicopters comprising a helibucket and a base, wherein said base comprises at least one autonomous fill valve.
